(19) United States
(12) Patent Application Publication
(10) Pub. No.: US 2008/0175094 A1
(43) Pub. Date: Jul. 24, 2008

(54) Solid Charging System

(76) Inventor: Bryan Henry, Morgantown, WV (US)

Correspondence Address: Bryan S. Henry, 2492 Fairmont Road, Morgantown, WV, 26501, US

(21) Appl. No.: 11/972,703

(22) Filed: Jan. 11, 2008

Related U.S. Application Data
(60) Provisional application No. 60/885,662, filed on Jan. 19, 2007.

(51) Int. Cl. B01F 15/02

(52) U.S. Cl. 366/165.3

(57) ABSTRACT

A system for charging flowable solids and mixing with water, including a solids charging hopper, a feed auger and a cyclonic mixer. The hopper has an open top with detents around the rim of the top which are capable of engaging and holding the rim of a container. The auger passes through the bottom section of the hopper, and the hopper can rotate about the axis of the auger, permitting inversion of a container attached to the detents. The auger feeds material from the hopper to the cyclonic mixer. The cyclonic mixer has a mixing chamber with a top surface having radial undulations or striae and a bottom discharge port with longitudinal undulations or striae for controlling vortex formation. Water is injected into the mixing chamber through a tangential inlet port.

### PRIOR APPLICATIONS

The Applicant claims the benefit of the filing date of a prior provisional application, No. 60/885,662, filed Jan. 19, 2007 and entitled, “Solid Charging System.”

### BACKGROUND OF THE INVENTION

1. Field of the Invention

The present invention relates to hoppers and cyclonic mixers for charging and mixing flowable granular solid ingredients.

2. Description of the Prior Art

In various manufacturing industries, including the manufacture and formulation of industrial cleansers and disinfectants, batches of aqueous chemical mixtures or formulations are prepared and processed. These formulations require the charging, or adding of various granular and powdered solids and liquid ingredients which comprise the formulation into mixing vessels of various designs.

One effective disinfectant formulation is described in U.S. Pat. No. 4,822,512, issued to Auchincloss. This formulation contains compounds including potassium monopersulfate, sulphamic acid, malic acid, sodium dodecylbenzene sulphonate, sodium chloride and anhydrous alkali metal phosphate. Some of these ingredients are highly hygroscopic, and readily adsorb moisture from atmospheric humidity.

These disinfectant formulations are often provided by manufacturers as a powder or in fine granules in small drums or pails with removable lids which are prepared for application by mixing in water to a concentration of between 1% and 3%. These solid materials are often charged into a process by first pouring the contents of a pail into a hopper. The material is then withdrawn from the bottom of the hopper at a controlled rate using solids conveying devices such as rotary valves or screw augers. The solid materials are then often mixed with a liquid carrier, typically water, forming an aqueous solution. The mixture is then further processed according to the needs of the formulation.

Some solid materials for producing disinfectant formulations handled in this manner are highly hygroscopic, and readily absorb moisture from the atmosphere. As these powders or granules absorb moisture, they become “sticky” and tend to agglomerate into larger solid clumps or balls of material. When this occurs, two problems often arise. First, processing the solid material becomes more difficult and time-consuming. The clumps tend to form plugs or blockage in the solids handling equipment, preventing any further flow of the material until the equipment is manually opened or disassembled and the agglomerated material is removed. Second, the clumps formed do not readily disperse in the aqueous medium or carrier, and remain as large suspended clumps, which unacceptably detracts from product quality and appearance.

When these hygroscopic materials are dumped from containers into the top of a hopper or bin, they are exposed to atmospheric humidity and moisture, which can be adsorbed by the hygroscopic materials, changing their physical properties. In the past, hoppers have been fitted with lids, which are closed after the material is charged. However, the hopper must be sized to hold the volume of an entire charge of material, at least the volume of a single container. Hoppers of these sizes have relatively large volumes and can hold significant amounts of atmospheric moisture, which may be adsorbed by the materials charged in the hopper awaiting further processing.

Mixing these hygroscopic ingredients for disinfectant solutions in the past has often been carried out in an agitated tank. An agitated tank generally is an upright, cylindrical vessel with flat or domed top and bottom heads. An agitator nozzle is disposed in the center of the top, on which is mounted an agitator drive. A vertical shaft extends from the agitator drive downward through the center nozzle and the interior of the vessel, terminating a short distance above the bottom head. Agitator blades or other mixing devices are mounted on the bottom end of the agitator shaft.

To mix a batch of disinfectant solution, a charge of water is added to the vessel. The agitator drive is started, which revolves the agitator blades in the water pool, creating a swirling turbulent pool of water. The solids are then added from the hopper through a second, solids inlet nozzle in the top head of the vessel, into this swirling turbulent pool, which are then dispersed throughout the fluid over time. The pool is agitated further for a sufficient time period for the solids to disperse, dissolve or react, as called for by the process.

The efficiency and time for the mixing operation depend on the nature and velocity profile in the mixing tank. Higher rotational speeds of the agitator generally result in higher turbulence, and more rapid mixing. But, if a simple paddle agitator (with blades parallel to the axis of the agitator shaft) is used in an unbaffled tank, at higher agitator speeds, tangential flow typically results, wherein the fluid circulates in a circular pattern around the tank wall, with little radial or axial flow components. This pattern is inefficient for mixing and requires longer times to disperse solid material into the fluid phase. This tangential flow is typically characterized by formation of a vortex, which is often undesirable, for process efficiency and product quality.

Improved designs have sought to reduce the proportion of the tangential flow component, and vortex formation, in the pool by using other types of impellers, such as propellers producing axial flow and various types of radial flow impellers. Baffles have also been used, which divert some of the tangential flow components into axial and radial flow components when the fluid impinges on the baffles.

Another class of mixing equipment used in mixing solids with water is the static mixer. Whereas the mixing tank uses an external source of power, namely the agitator drive and agitator blades, to increase the kinetic energy of the fluid, static mixers use the internal energy, namely pressure, of the fluid, which is converted to kinetic energy to provide turbulence and agitation.

One such static design is a cyclonic mixer. In a cyclonic mixer, a vessel with a tapered bottom is provided, with a vertical solids inlet port for introducing solids in the center of the circular top. A liquid inlet nozzle is provided in the side wall of the mixer to introduce a pressured stream of water or other fluid tangentially to the interior surface of the cone. As the fluid flows through the liquid inlet nozzle, its potential energy is converted to kinetic energy, in the form of higher velocity. The liquid flows at this higher velocity, around the cylindrical wall a the top of the cyclone, spiraling downward into a turbulent swirling pool at the bottom of the cyclone. Solids fall from the solids inlet port into the turbulent pool, where they are mixed and dispersed in the fluid phase. The fluid mixture is continuously withdrawn from a discharge port at the bottom of the cyclone, which then proceeds to the next step in the formulating process.

For example, U.S. Pat. No. 2,528,514, issued to Harvey et al., describes a superphosphate reaction vessel, comprising a vessel as a frustum of a cone, with an open bottom, a plurality of nozzle lines distributed around the interior wall of the vessel, and a vertical solids inlet in the center of the vessel top. Nozzles at the end of each nozzle line are angled acutely to the longitudinal axis of the vessel and tangentially to the interior surface. Phosphoric acid solution is ejected from the nozzles, forming a spiraling turbulent flow around the lower wall of the vessel, and a turbulent pool at the bottom. Finely ground phosphate rock is discharged through the center chute, which contacts the pool and then is quickly dispersed and reacted to form a desired end-product. However, this system is necessarily large and, because of the necessarily small bottom opening needed to produce a pool at the bottom of the vessel to catch descending phosphate rock particulates, has a relatively large residence time and low through-put to volume ratio. It is also designed for ground phosphate rock, which is relatively free-flowing.

The degree of turbulence in the liquid phase in a cyclonic mixer, and the rate at which liquids and solids can be blended, is proportional to the rotational velocity of the fluid, which in turn is proportional to the velocity of the liquid inlet stream and inversely proportional to the diameter of the cyclone. Thus, a smaller mixer will have higher turbulence and more rapid mixing, and, coincidentally, a lower manufactured cost.

However, at some point, higher rotational velocities in the cyclone will result in nearly complete tangential flow, producing a vortex, similar to mechanically agitated mixing vessels at high agitation speeds. In the art of agitation engineering, a dimensionless number found useful for describing the extent of mixing and turbulence is the Froude Number, which is a dimensionless ratio of the inertial force to the gravitational force on a fluid. For a particular vessel geometry, the Froude Number provides an indication of where the flow pattern will revert to essentially tangential flow, as indicated by the formation of a vortex. Improvements in mixer design have sought to increase the Froude Number at which vortex formation occurs, usually by means of diverting part of the tangential velocity component into radial or axial flow components.

In Harvey, the nozzles were disposed at an acute angle rather than perpendicularly, to the longitudinal axis of the cyclone. This design divides the fluid stream into both tangential and axial components, thereby precluding vortex formation to a higher Froude number, and thereby a higher fluid velocity, thus improving mixing efficiency. However, better mixer designs can provide operation at higher Froude Numbers, with greater turbulence and more effiecient mixing, without onset of vortex formation.

### SUMMARY OF THE INVENTION

To overcome the limitations of the prior art, the invention herein provides, first, for an improved solids charging hopper. The hopper has a top rim which is formed to latch or engage onto the rim of a chemical shipping container, in a manner similar to how the container's lid would attach. This provides minimal exposure to atmospheric moisture, which can cause agglomeration and reduced flowability of the chemical contents of the container. The hopper also has a feed auger traversing through the bottom section of the hopper, normal to the longitudinal axis of the hopper. To then facilitate discharge of the contents of the container, the hopper is rotatable, preferably over an arc of at least 120 degrees, around the axis of the auger, at which point the contents of the container can discharge by gravity into the hopper.

The combination of the latching rim and the rotating hopper provide a means for emptying the contents of a chemical container with only seconds of exposure to atmospheric moisture and humidity. The only exposure to atmospheric moisture results from the period between removing the lid of the chemical container and engaging the container to the rim of the charging hopper.

Second, the invention provides for a cyclonic mixer, improved with means for inhibiting formation of a vortex, thereby permitting higher liquid flowrates, or smaller cyclones for the equivalent liquid flow rate.

Vortices are inhibited in the cyclone mixer of the present invention by use of radial undulations or striae on the interior surface at the top of the cyclone, and by longitudinal undulations or striae around the interior surface in the discharge nozzle at the bottom of the cyclone. The undulations or striae at the top create eddies in the incoming fluid jet stream, increasing the radial turbulence of the spinning fluid stream, and thereby inhibiting formation of a vortex. The longitudinal undulations or striae in the discharge after the bottom outlet of the cylcone likewise create radial eddies, breaking up the circular flow and better allowing the fluid stream to drop by gravity from the cyclone.

One object of the invention is to provide a solids charging hoppe which reduces the exposure of flowable solids ingredients to atmospheric moisture.

Another objective is to provide a rotating hopper for easier solids charging from shipping containers.

Another objective is to provide a rotating hopper with latching means to secure a shipping container to the rim of the rotating hopper.

Another objective is to provide a cyclonic mixer which can operate at higher fluid velocities without the onset of vortex formation.

These and other objectives and advantages of the invention will become apparent from the description which follows. In the description, reference is made to the accompanying drawings, which from a part hereof, and in which is shown by way of illustration specific embodiments in which the invention may be protected. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### DESCRIPTION OF THE DRAWINGS

FIG. 1A is an isometric view of the invention, showing an embodiment comprising a charging hopper with a circular top opening.

FIG. 1B is an isometric view of a solids charging system, showing an embodiment comprising a charging hopper with a rectilinear top opening.

FIG. 2 is a side elevation view of a solids charging system, with sectional views of the charging hopper and a casing extension.

FIG. 3A is a side elevation of the charging hopper in an inverted attitude.

FIG. 3B is a side elevation of the charging hopper in an upright attitude.

FIG. 4 is an elevation sectional view of the cyclonic mixer.

FIG. 5 is an perspective illustration of the cyclonic mixer with cylindrical shell removed, displaying the radial striae or undulations on the top member.

FIG. 6A is a sectional elevation of a section the cyclonic mixer, displaying one embodiment of the bottom discharge.

FIG. 6B is a sectional elevation of a section of the cyclonic mixer, displaying another embodiment of the bottom discharge.

### DETAILED DESCRIPTION OF EMBODIMENTS OF THE INVENTION

The following discussion describes in detail one or more embodiments of the invention. The discussion should not be construed, however, as limiting the invention to those particular embodiments, and practitioners skilled in the art will recognize numerous other embodiments as well. The complete scope of the invention is defined in the claims appended hereto.

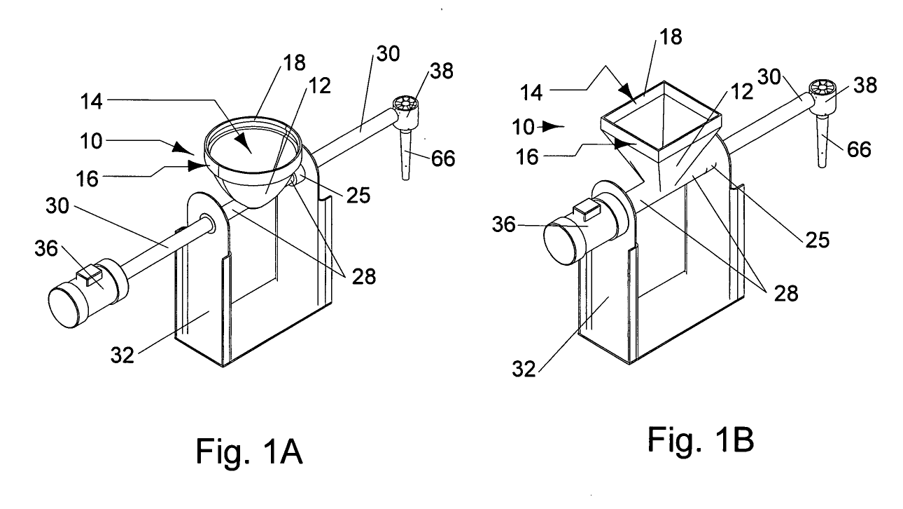

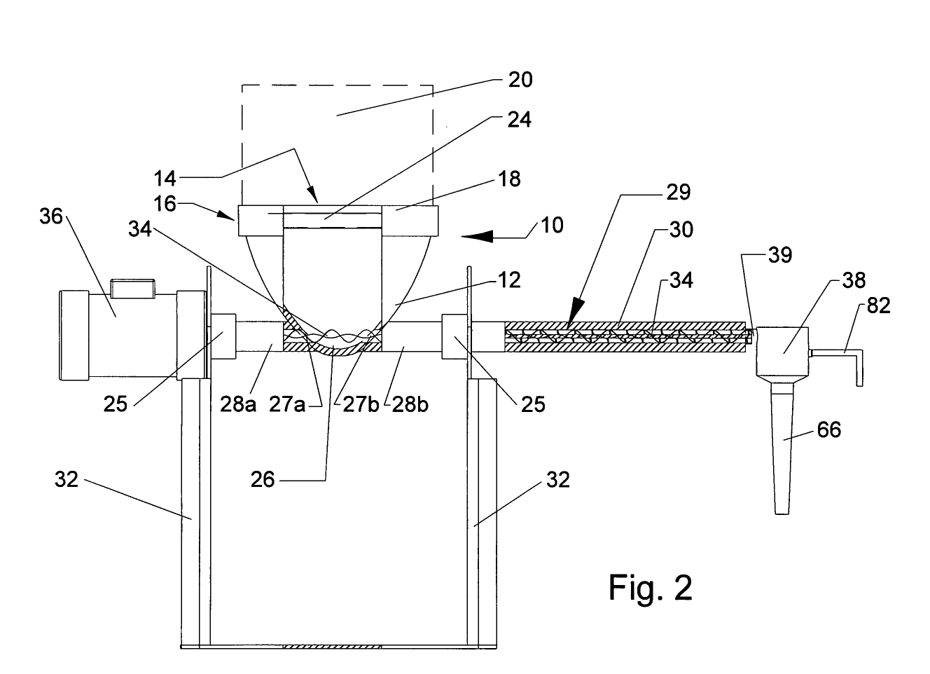

To overcome the limitations found in the prior art, an improved solids charging system is provided. As shown in FIGS. 1A, 1B and 2, the solids charging system comprises, in part, of a charging hopper 10 and a cyclonic mixer 38.

The charging hopper 10 comprises a tapered vessel 12 with a top opening 14. The tapered vessel 12 may be conical in shape, with a circular or elliptical top opening 14, as shown in FIG. 1A, or may be pyramidal, as shown in FIG. 1B, with a top opening 14 having a square, rectangular or other polygonal shape.

As best shown in FIG. 2, the lower part of the tapered vessel 12 converges to a narrow apex, forming a closed bottom end section 26. Proximate to the bottom end section 12 are opposing, first and second coaxial apertures 27a, 27b in the wall of the tapered vessel 12. First and second mounting nozzles 28a, 28b may be disposed on the exterior of the tapered vessel 12 coaxial with the apertures 27a, 27b to permit attachment of casing extensions 30 or ancillary equipment to the charging hopper 10.

The ends of the two mounting nozzles 28a, 28b distal from the charging hopper 10 are rotationally connected to other process equipment or supports. At the first mounting nozzle 28a, a drive source, such as an electric motor 36, typically would be installed to provide the motive force for a solids conveying device, such as a screw auger 34, described infra and shown in FIG. 2. Alternatively, a casing extension 30 may be disposed between the first mounting nozzle 28a and the electric motor 36 as needed to provide clearance, as shown in FIG. 1A.

On the second mounting nozzle 28b, may be installed a cyclonic mixer 38, having a solids inlet port 39. Alternatively, a second casing extension 30 may be disposed between the second aperture 27b, or its adjacent mounting nozzle 28b, and the cyclonic mixer 38, as shown in the figures.

In various embodiments of the invention, one, two or no casing extensions 30 may be provided. As shown in FIG. 2, a casing extension 30 is provided between the second mounting nozzle of the second aperture 27b of the charging hopper 10 and the cyclonic mixer 38, to provide clearance as needed, while the motor 36 is coupled directly to the second mounting nozzle 28b of the second aperture 27b. Alternatively, a casing extension 30 could also be provided between the motor and the first mounting nozzle 28a, as shown in FIG. 1A.

The casing extension(s) 30, when used, will have a central, longitudinal cavity. These cavities, together with the bores of the mounting nozzles 28a, 28b, the two apertures 27a, 27b and the interior of the closed bottom 26 of the tapered vessel 12, provide an extended, continuous channel 29 from the end of the motor to the open end of the solids inlet port 39 of the cyclonic mixer 38. The channel 29 will have a cross-section suitable for solids conveying apparatus, discussed below. Typically, this is a circular cross-section.

A solids conveying apparatus is provided within this continuous central cavity. Preferably, this would be a screw auger 14. A screw auger 14 has the shape of a helix, the flutes of which transport solids through the channel 29 as the screw auger 14 is rotated. The screw auger 14 extends through the continuous channel 29 defined by the mounting nozzles 28 and any casing extensions 30. One end of the auger 14 attaches to the motor 16, which can rotate the auger 14 within the continuous channel 29. The other end of the screw auger 14 extends to, or possibly into, a solids inlet port 39 on the cyclonic mixer 38. The screw auger 34 is in communication with the interior of the tapered vessel 12 at the closed bottom 26 where it traverses between the two apertures 27a, 27b.

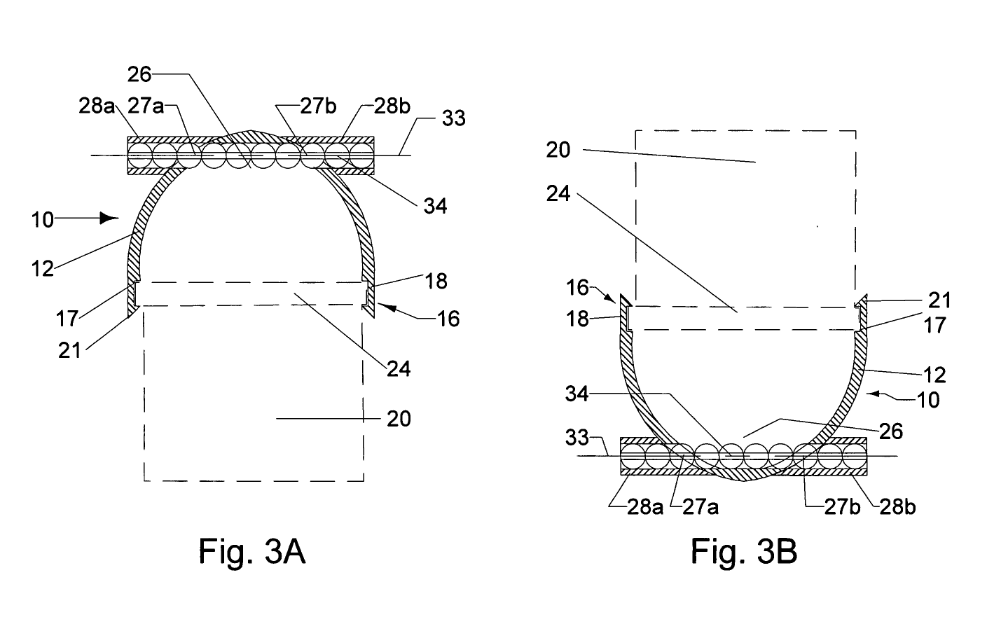

The end sections of the mounting nozzles 28a, 28b, distal from the charging hopper 10 rotationally articulate with the adjacent equipment by means of dust-tight bearing assemblies 25. Such an assembly may be formed with rotary bearings and dust seals, using designs known in the art, such as that taught in U.S. Pat. No. 4,379,600. This articulation permits the charging hopper to rotate about the longitudinal axis 33, shown in FIGS. 3A and 3B, of the channel 29. In FIG. 3A, the charging hopper 10 is displayed rotated to the full inverted position, while in FIG. 3B it is displayed in the full upright position.

Referring to FIGS. 3A and 3B, the rotating charging hopper 10 permits a shipping container 20 of a disinfectant formulation to be quickly attached and sealed to the rim 16 of the charging hopper 10. As shown in FIG. 3A, a container 20 typically has a lip 24, collar or bead around the perimeter of its open top, to which a lid (not shown), having latches, clips or the like, is affixed to keep the formulation ingredients sealed within the container 20. The rim 16 of the open top 14 of the charging hopper 10 has a similar design, having a rabbet 17 with one or more detents 18 disposed around its perimeter. In a preferred embodiment, the detents 18 are tough and semi-pliant and have a hook end 21, which is sized to latch under the lip 24 of the shipping container 20, once the container 20 has been seated on the shoulder of the rabbet 17. Optionally, a strapping clamp (not shown) around the detents 18 may be provided to prevent the detents 18 from unintentionally releasing under the weight of larger or heavier containers 20.

Once a container 20 has been seated on the rim 16 of the charging hopper 10, the charging hopper 10 can then be rotated upward around the channel longitudinal axis 33, preferably at least 120°, and more preferably 180° to a fully upright position, as shown in FIG. 3B. The contents of the shipping container 20 then flow by gravity into the tapered vessel 12 of the charging hopper 10, where they can then be conveyed by the screw auger 34 through the channel 29. For the container sizes which will typically be unloaded using the present invention, the charging hopper 10 can be rotated manually. Rotation can also be assisted with a power source by disposing a sprocket or sheave around a mounting nozzle, to which is attached a drive belt and controllable power source. Hydraulic actuators may also be used to rotate the charging hopper to its desired attitude.

By affixing the shipping container 20 to the rim 16 of the charging hopper 10, the solids ingredients in the container 20 are exposed to atmospheric moisture only for the short time period between removing the container's 20 lid and attaching the container 20 to the inverted charging hopper 10. The charging hopper 10 is then rotated, bringing the charging hopper 10 into its upright position and inverting the container 20. As the container 20 remains attached to the charging hopper 10, the charging hopper 10 need not be sized to hold the contents of a full container 20, and need only be large enough to funnel and direct the solids ingredients into the screw auger 34 at the bottom end section 26 of the charging hopper 10. This reduces the necessary volume of the tapered vessel 12, and consequently the volume of air and atmospheric moisture in the charging hopper 10 prior to connecting the container.

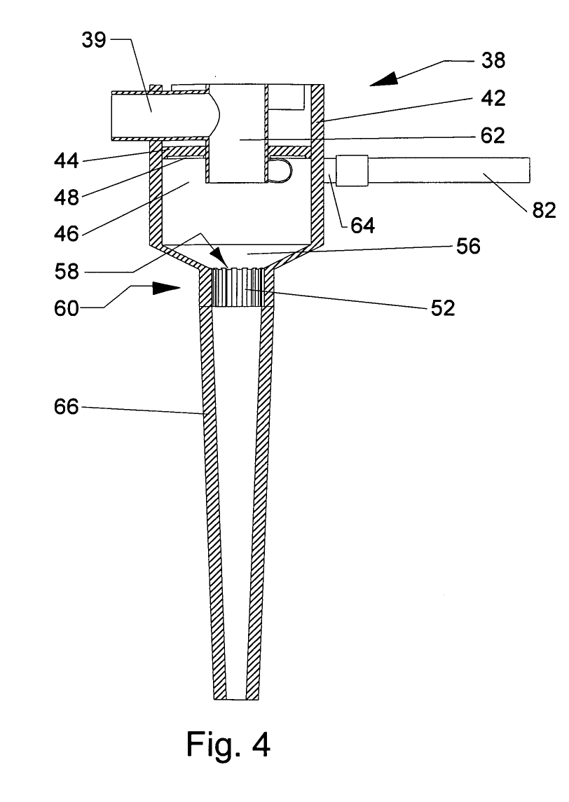

At the second mounting nozzle 28b, or at the distal end of any casing extension 30 attached thereto, is disposed a cyclonic mixer 38. As shown in FIG. 4, the cyclonic mixer 38 comprises, in part, of top member 44 and a cylindrical shell 42, which enclose and define an upper chamber section 46, wherein the wall of the cylindrical shell 42 is straight. Below the upper chamber section, the cylindrical shell tapers radially inward to a bottom opening 58, defining a lower chamber section 56. A tubular solids inlet chute 62 is disposed through the center of the top member, and extends into or through the upper chamber section. The top of the tubular solids inlet chute extends above the top member 44 and is in communication with the solids inlet port 39. The cylindrical shell 42 extends above the top member 44 as well to provide support for the solids inlet port 39 and solids inlet chute 62.

A bottom discharge 60 is disposed at the bottom opening 58, to which a discharge line 66 and subsequent downstream processing equipment may be disposed.

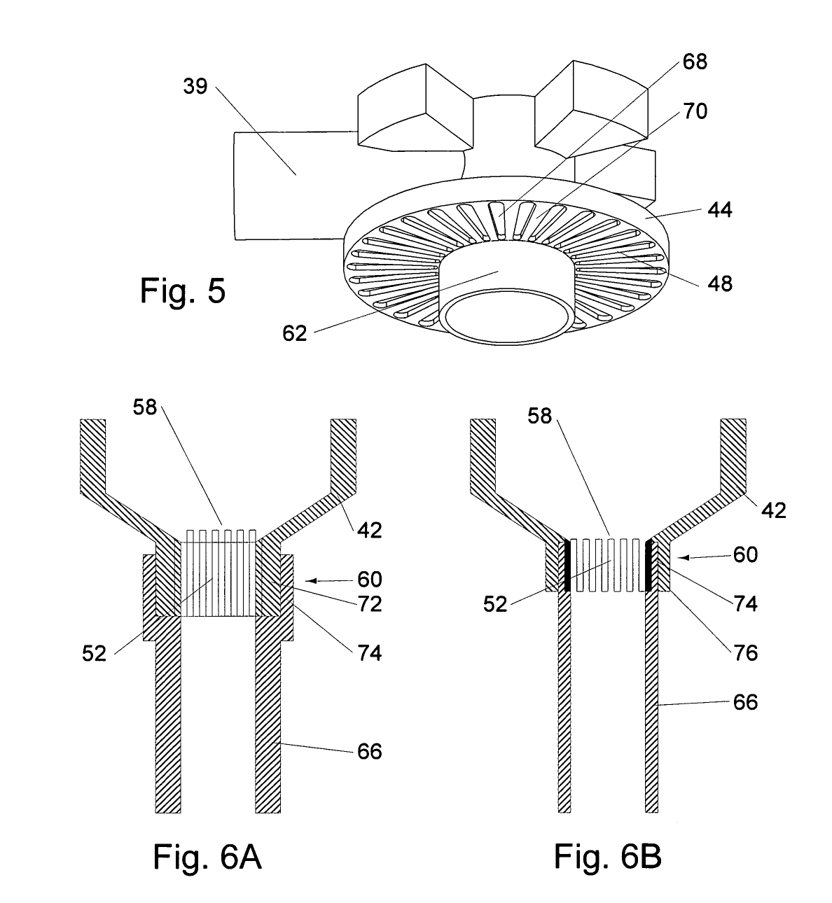

The lower surface of the top member 44, proximate to the interior of the upper chamber section 46, has disposed therein radial striae or undulations 48. This is shown best in FIG. 5, wherein the cylindrical shell of the cyclonic mixer has been removed and the top member 44 is viewed from below. These radial striae or undulations 48 extend radially from proximate to the solids inlet chute 62 to proximate the perimeter of the top member 44. The radial striae or undulations 48 typically comprise a series of grooves 68, separated by ridges 70. The width of the grooves 68 and ridges 70 will be narrow near the center of the top member, having a lesser circumference at that point, gradually widening over the length of the radial straie or undulation 48 towards the outer perimeter of the top member 44. The tangential width and cross-sectional shape of the grooves 68 and ridges 70 can vary in different embodiments, n the preferred embodiment comprising grooves of flat bottoms and straight sides and flat ridges, as shown in FIG. 7A. The widths of the ridges 70 and grooves 68 across any concentric circle within the perimeter of the lower surface are equal in the preferred embodiment, but may vary from either extremes of narrow to wide for the grooves 68, and inversely for the ridges 70. The ridges 70 may be so narrow as to essentially amount to vanes disposed normal to the surface formed by the grooves 68. The grooves 68 and ridges 70 need not be flat, and need not have distinct or straight sides separating them. In one embodiment, shown in FIG. 8B, the tangential cross-section of the interior surface is sinusoidal, with convex ridges 70 and concave grooves 68. In another embodiment, not shown, one side of the groove 68 is straight and normal to the bottom of the groove 68, while the other side is straight, but canted at an angle to the bottom.

Returning to FIG. 4, the lower chamber section 56 of the cyclonic mixer 38 is preferably at least partially tapered, either linearly as an inverted frustum, or non-linearly, such as a hemispherical bottom head. At the bottom, narrow end of the lower chamber section 56 is a circular bottom opening 58. Disposed at the bottom opening 58 is a tubular bottom discharge 60. The bottom discharge 60 defines an elongated central channel, preferably with a circular cross section. The interior wall of the bottom discharge 60 has longitudinal striae or undulations 52, disposed circumferentially around the interior of the bottom discharge 60. Like the radial striae or undulations 48, the longitudinal striae or undulations 52 have grooves 68 and ridges 70 of varying width proportions and cross-sectional shapes, including straight and arcuate, as was shown in FIGS. 7A and 7B.

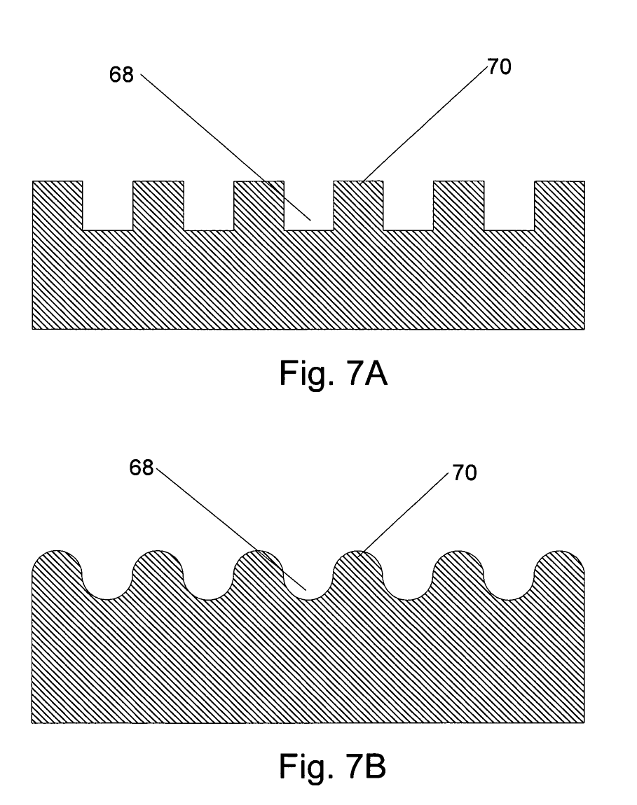

The bottom discharge 60 may be of several designs. In one embodiment, shown in FIG. 6A, a nipple 72 is disposed on the bottom opening 58, over which a discharge line 66 having a proximate socket 74 is registered on the nipple 72. The longitudinal straie or undulations 52 would be disposed at least around the interior surface of the nipple, and possibly continuing into the interior of the discharge line 66 proximate to the socket 74. Alternatively, as shown in FIG. 6B, a socket 74 may be disposed on the cylindrical shell 42 at the bottom opening 58, into which a stub 76 on the proximate end of a discharge line 66 is engaged. In this embodiment, the longitudinal striae or undulations 52 would be disposed around the interior of the stub 76 and, possibly, further down the length of the discharge line 66.

The nipples, stubs and sockets can be joined together by various means known in the art, such as by screw threads, flanges, adhesives or clamps.

A water inlet nozzle 64 is provided in the cylindrical shell 42, proximate to the upper chamber section 46, and is aligned tangentially with its interior surface. A regulated source of water 82, under some pressure greater than ambient, is provided to the water inlet nozzle 64.

The cyclonic mixer 38 is attached by its solids inlet port 39 to the distal end of the mounting nozzle 28 on the second aperture 27b, or on any subsequent casing extension 30 mounted between the mounting nozzle 28 and the solids inlet port 39. The solids inlet port 39 is aligned coaxially with the channel 29. In the preferred embodiment, the solids inlet port 39 joins perpendicularly with an extension of the solids inlet chute 62 above the top member 44.

In operating the invention, again referring to FIGS. 1A, 1B, 2, 3A and 3B, the charging hopper 10 is first rotated to an inverted position or attitude, as shown in FIG. 3A, with the open top 14 directed downward. A container 20 of solids ingredients is provided, and the lid of the container 20 is removed. The container 20 is then seated by its lip 24 onto the shoulder of the rabbet 17 of the charging hopper 10, such that the detent(s) 18 latch under the lip 24. The charging hopper 10 is then rotated, placing the container 20 above the horizontal plane, and preferably vertically above the charging hopper 10, filling the charging hopper 10 with the solids ingredients. The source of water 82 to the water inlet nozzle 64, as shown in FIG. 2, is opened or energized, and the flow of water into the water inlet nozzle 64 is adjusted.

The charging hopper 10 is secured at the upright attitude to preclude further undesired rotation, and the motor 36 is energized, which begins rotation of the auger 34. The auger then transports the solids ingredients through the channel 29, into the solids inlet port 39 of the cyclonic mixer 38. The solids ingredients drop through the solids inlet chute, into the turbulent pool of water in the lower chamber section 56, where they are intimately mixed. The radial striae or undulations 48 on the top member 44 interior surface and the longitudinal striae or undulations 52 in the interior surface of the bottom discharge prevent formation of a vortex at fluid velocities at and beyond those velocities at which vortices form in conventional cyclonic mixers.

The strength or concentration of the mixture or solution formed in the cyclonic mixer 38 may be regulated by regulating the flow of the source of water 82 to the water inlet nozzle 64, or adjusting the rotational speed of the auger. Typically, the water flow rate is regulated to achieve optimal turbulence and mixing in the cyclonic mixer 38, and the auger 34 rotational speed is adjusted to achieve the desired solution concentration.

While various embodiments of the invention have been described above, it should be understood that they have been presented by way of example, and not limitation. It will be apparent to persons skilled in the relevant art that various changes in form and detail may be made therein without departing from the spirit, and scope and application of the invention. This is especially true in light of technology and terms within the relevant art that may be later developed. Thus, the present invention should not be limited by any of the above-described exemplary embodiments, but should only be defined in accordance with the appended claims and their equivalents.

I claim:

1. A solids charging system, comprising:
(a) a charging hopper, comprising:
i. a tapered vessel, having an open top at the wide end section of the vessel,
ii. a rim disposed at the perimeter of the open top adapted for registration of a top edge of a shipping container,
iii. a closed bottom disposed at the narrow end section of the vessel, and
iv. a first and second opposing collinear apertures adjacent to the bottom,
v. a first and second mounting nozzle, each mounting nozzle defining a longitudinal channel having a longitudinal axis and each mounting nozzle disposed on the respective first or second aperture, each mounting nozzle having a distal end rotationally engaging an adjacent device;
(b) optionally, a first or a second, casing extension, or a combination of the two, each casing extension defining a longitudinal channel, wherein a first end of the channel of each casing extension is collinearly disposed on the channel of either of the mounting nozzles of the charging hopper;
(c) a cyclonic mixer, comprising:
i. a cylindrical shell having a bottom opening, a lower section of the cylindrical shell inwardly tapering towards a bottom opening, a circular top member disposed within the cylindrical shell, the cylindrical shell and top member defining an interior chamber, and the top member having a interior surface directed towards the chamber, and radial striae or undulations disposed in the interior surface,
ii. a bottom discharge disposed at the bottom opening, the bottom discharge comprising a tubular body having longitudinal striae or undulations disposed around its interior circumference,
iii. a liquid inlet nozzle disposed in the cylindrical shell,
iv. a tubular solids inlet chute disposed centrally in the top member and extending into the chamber,
v. a tubular solids inlet port, in physical communication with the solids inlet chute;
(d) an auger, traversing through the channel, in communication with the interior of the tapered vessel, having a first end engaging with the solids inlet port.

2. The solid charging system of claim 1, further comprising a source of rotational power engaging with a second end of the auger.

3. The solids charging system of claim 1, further comprising a discharge line disposed on the discharge nozzle of the cyclonic mixer.

4. The solids charging system of claim 1, wherein the cylindrical wall of the cyclonic mixer is partially tapered, and the solids inlet tube extends into the interior of the chamber to a point where the interior diameter of the chamber begins to taper.

5. The solids charging system of claim 1, wherein the radial undulations in the interior surface of the top member and the longitudinal undulations in the comprise ridges and grooves.

6. The solids charging system of claim 1, wherein the radial striae undulations in the top member comprise grooves with flat bottoms and straight sidewalls disposed in the interior surface of the top member of the cyclonic mixer.

7. The solids charging system of claim 1, wherein the longitudinal striae or undulations in the discharge nozzle comprise a plurality of grooves with flat bottoms and straight sidewalls disposed in the interior surface of the discharge nozzle.

8. The solids charging system of claim 1, wherein the radial undulations of the top member are comprised of vanes disposed radially on the interior surface of the top member of the cyclonic mixer.

9. The solids charging system of claim 1, wherein the longitudinal undulations of the discharge nozzle of the cyclonic mixer are comprised of vanes disposed longitudinally on the interior surface of the discharge nozzle.

10. The solids charging system of claim 1, wherein the charging hopper is conical.

11. The solids charging system of claim 1, wherein the charging hopper is pyramidal.

12. The solids charging system of claim 1, wherein the rotational engagement between each auger casing and either aperture further comprises a seal for preventing solids leakage.

13. A solids charging hopper, comprising:
(a) a charging hopper, comprising:
i. a tapered vessel, having an open top at the wide end section of the vessel,
ii. a rim disposed at the perimeter of the open top having means for registration with a top edge of a shipping container,
iii. a closed bottom disposed at the narrow end section of the vessel, and
iv. two opposing collinear apertures adjacent to the bottom;
(b) a first and second mounting nozzle, each having a distal end, the mounting nozzles defining a longitudinal channel with a longitudinal axis, wherein each distal end rotationally engages with an adjacent device;
(c) a solids conveyor disposed in the longitudinal channel of the first and second mounting nozzles and in physical communication with the interior of the vessel, capable of conveying flowable solids from the bottom of the vessel to one of the adjacent devices.

14. The solids charging hopper of claim 13, wherein the vessel is capable of rotating 180 degrees about the longitudinal axis.

15. The solids charging hopper of claim 13, wherein the means for registration with a top edge comprises one or more detents for releasably engaging the top edge of a shipping container.

16. The solids charging hopper of claim 13, wherein the solids conveyor is a screw auger.

17. The solids charging hopper of claim 16, further comprising a source of rotational power engaged with the screw conveyor.

18. The solids charging hopper of claim 13, wherein an adjacent device is selected from the group consisting of a cyclonic mixer and a casing extension.

19. The solids charging hopper of claim 13, wherein an adjacent device is selected from a group consisting of a cyclonic mixer and a casing extension.

20. The cyclonic mixer of claim 13, wherein the open top is circular.

21. The cyclonic mixer of claim 13, wherein the open top is rectilinear.

22. A cyclonic mixer for mixing and dispersing granulated or powdered solids in a liquid, comprising:
(a) a cylindrical shell having a bottom opening, a lower section of the cylindrical shell inwardly tapering towards a bottom opening, a circular top member disposed within the cylindrical shell, the cylindrical shell and top member defining an interior chamber, and the top member having a interior surface directed towards the chamber, and radial striae or undulations disposed in the interior surface;
(b) a bottom discharge disposed at the bottom opening, the bottom discharge comprising a tubular body having longitudinal striae or undulations disposed around its interior circumference,
(c) a liquid inlet nozzle disposed in the cylindrical shell,
(d) a tubular solids inlet chute disposed centrally in the top member and extending into the chamber.

23. The cyclonic mixer of claim 22, further comprising a tubular solids inlet port disposed orthogonally to and in physical communication with the solids inlet chute.

24. The cyclonic mixer of claim 22, further comprising means for transporting flowable solid powders or granules to the solids inlet port.

25. The cyclonic mixer of claim 24, wherein the means for transporting flowable solid powders or granules is an auger.

26. The cyclonic mixer of claim 22, wherein the radial striae or undulations comprise grooves and ridges with flat cross sections, separated by straight sides.

27. The cyclonic mixer of claim 22, wherein the radial striae or undulations comprise grooves and ridges with arcuate cross-sections.

28. The cyclonic mixer of claim 22, wherein the longitudinal striae or undulations comprise grooves and ridges with flat cross-sections, separated by straight walls.

29. The cyclonic mixer of claim 22, wherein the longitudinal striae or undulations comprise grooves and ridges with arcuate cross-sections.

30. The cyclonic mixer of claim 22, wherein the liquid inlet nozzle is disposed tangentially to the interior surface.
